(19) United States
(12) Patent Application Publication
(10) Pub. No.: US 2025/0138500 A1
(43) Pub. Date: May 1, 2025

(54) Systems and Methods for Controlling Dynamic Environments

(71) Applicant: Opteon Corporation, Hudson, MA (US)

(72) Inventor: T. Eric Hopkins, Wellesley, MA (US)

(21) Appl. No.: 19/011,106

(22) Filed: Jan. 6, 2025

Related U.S. Application Data
(63) Continuation of application No. PCT/US2023/069664, filed on Jul. 5, 2023.
(60) Provisional application No. 63/358,260, filed on Jul. 5, 2022.

(51) Int. Cl. G05B 19/042

(52) U.S. Cl. CPC G05B 19/0423

(57) ABSTRACT

Apparatus and methods for controlling and communicating with a plurality of devices in a dynamic environment. A controller can issue commands to one or more of the devices in the dynamic environment and receive information based on signals from one or more of the devices in the dynamic environment. The commands from the controller and the signals from the devices can be transformed to different signaling types by flexible I/O circuitry connected between the controller and plurality of devices to establish compatible communications between the controller and the devices, thereby accommodating a wide variety of signaling types. Signal-processing-resource circuitry (SPRe circuitry) is additionally implemented between the controller and devices to offload signal-processing tasks from the controller to the SPRe circuitry. The offloading can provide low-latency responses by the controller to conditions arising in a complex dynamic environment and can further reduce processing time associated with the signal-processing tasks.

### CROSS-REFERENCE TO RELATED APPLICATION

This application is a bypass continuation of International Application No. PCT/US2023/069664, titled “Systems and Method for Controlling Dynamic Environments,” filed on Jul. 5, 2023, which claims the priority benefit to U.S. Application No. 63/358,260, titled “Systems and Methods for Controlling Dynamic Environments,” filed on Jul. 5, 2022, which application is incorporated herein by reference in its entirety.

### BACKGROUND

Modern automated control systems can include a large number of controlled devices, sensors, actuators, cameras, and one or more controllers (e.g., microprocessors or microcontrollers). The controller(s) can receive and process data from at least the sensors and cameras and issue commands to operate the controlled devices based, at least in part, on the data received. Such automated control systems can operate in combination with dynamic environments where conditions in the environment change frequently causing changes in one or more sensor outputs, changes in responses by the control system and changes in control signals output by the controller(s).

### SUMMARY

The inventors have recognized and appreciated that sensing and control systems for dynamic environments should be fast (e.g., reflexively responsive), with very low latency between receipt of signals and data from connected devices in the environment (e.g., sensors, motors, actuators, lighting equipment, robotics equipment, imaging devices such as cameras, etc.) and transmission of control signals to the controlled devices that operate in the dynamic environment. Further, sensing and control systems should be flexible to handle a wide variety of signaling types including different digital and analog signaling types.

Previous work by the inventors relates to appreciably low latency control systems for dynamic environments, as well as flexible input/output circuitry to dynamically accommodate a variety of different signal types (e.g., transmission and/or reception of single-ended digital and analog signaling types and/or differential digital and analog signaling types analog signals) for multiple devices in the dynamic environment. Regarding this previous work, example implementations of low latency control systems can be found in U.S. Pat. No. 9,459,607, entitled “Methods, Apparatus, and Systems for Monitoring and/or Controlling Dynamic Environments,” issued Oct. 4, 2016, which patent is incorporated herein by reference in its entirety. Example implementations of flexible input/output circuitry can be found in U.S. Pat. No. 11,182,326, entitled “Input/Output Apparatus and Methods for Monitoring and/or Controlling Dynamic Environments,” issued Nov. 23, 2021, which patent is incorporated herein by reference in its entirety.

In view of the foregoing, the inventive implementations described in the present disclosure generally relate to augmenting the signal processing architecture of the inventors' previous work while at the same time maintaining or further decreasing the latency (or increasing the reflexive responsiveness) of such systems by the addition of signal-processing-resource circuitry (SPRe circuitry). In various examples, the SPRe circuitry is communicatively coupled to both the flexible input/output circuitry and also to one or more controllers so as to form a holistic control system for a dynamic environment. Examples of signal processing functionality that may be performed by the SPRe circuitry on signals or other information received from the controller(s), as well as signals or other information received from the flexible input/output circuitry, include but are not limited to: analog filtering; digital filtering; frequency and/or phase detection; normalization, scaling and/or other transformation (e.g., via one or more look-up tables or “LUTs”); digital signal generation; and analog signal generation.

In various aspects, SPRe circuitry as disclosed herein can be particularly configured by one or more controllers (including those controllers previously disclosed by the inventors) to perform a variety of signal processing and/or signal generation functionality; further, the controller(s) that configure the signal processing and/or signal generation functionality of the SPRe circuitry may also provide one or more signals to be processed by the SPRe circuitry (e.g., for transmission ultimately to one or more devices in the dynamic environment, via the flexible input/output circuitry). Likewise, the SPRe circuitry may receive one or more signals from the flexible input/output circuitry (which signals are provided in the first instance to the flexible input/output circuitry by one or more devices in the dynamic environment); the SPRe circuitry can process these signals received from the flexible input/output circuitry (in some instances based at least in part on particular configuration of the SPRe circuitry by the controller(s)) and in turn transmit the processed signals to the controller(s).

In some example implementations, as discussed in further detail below, SPRe circuitry according to the inventive concepts disclosed herein can include multiple processing resources. In one aspect, each of the processing resources of the SPRe circuitry may be particularly configured at a given time (e.g., by one or more controllers) to perform some type of signal processing or signal generation on a signal provided to the SPRe circuitry by either the controller(s) or the flexible input/output circuitry. In one example, a first processing resource of the SPRe circuitry may be configured by the controller(s) for a first type of signal processing or signal generation on a first signal (received from the controller(s) or from the flexible input/output circuitry), and a second processing resource of the SPRe circuitry may be configured by the controller(s) for a second type of signal processing or signal generation on the first signal and/or a second signal received from the controller(s) or the flexible input/output circuitry). Furthermore, the first processing resource of the SPRe circuitry may alternatively or additionally configure and/or trigger operation of the second processing resource of the SPRe circuitry to perform the second type of signal processing or signal generation or yet another type of signal processing or signal generation on the first signal, the second signal, and/or a third signal received from the controller(s) of the flexible input/output circuit.

In view of the foregoing, it should be appreciated that the respective processing resources of the SPRe circuitry in various example implementations may be flexibly and dynamically configured (and reconfigured) to perform some type of signal processing and/or signal generation in connection with “outbound” signals (from the controller(s) to the SPRe circuitry, then to the flexible input/output circuitry, then to the one or more devices in the dynamic environment) as well as “inbound” signals (from the one or more devices in the dynamic environment to the controller(s), via the flexible input/output circuitry and the SPRe circuitry). Additionally, it should be appreciated that at least a first processing resource of the SPRe circuitry may communicate directly with one or more other processing resources of the SPRe circuitry to configure and/or trigger operation of the one or more other processing resources, in some instances based at least in part on the processing or generation of a signal by the first processing resource. In this manner, multiple processing resources of the SPRe circuitry may be employed in tandem (e.g., concurrently and/or sequentially, as in a “cascade” of events and actions) to perform corresponding types of signal processing and/or signal generation with little to no intervention or configuration by the controller(s) (or any significant use of processing bandwidth of the controller(s)).

The foregoing concept of one processing resource of the SPRe circuitry being capable of dynamically configuring and/or triggering operation of one or more other processing resources of the SPRe circuitry is referred to herein as “cross-communication between multiple processing resources.” The SPRe circuitry can thereby offload signal-processing tasks that would otherwise by handled by the controller(s), freeing up the controller(s) to attend to other system management and control tasks. In various aspects, the offloading of signal processing bandwidth from controller(s) to the SPRe circuitry and the speed of the SPRe circuitry can significantly decrease the overall latency of the sensing and control system.

Some implementations relate to a control system comprising: a controller to issue control signals for controlling a at least one controlled device in a dynamic environment; flexible input/output (I/O) circuitry communicatively coupled to the controller and to the at least one controlled device to transform at least one first signal of a first signaling type from the controller to a second signal of a second signaling type that is supported by a first controlled device of the at least one controlled device; and a signal processing resource communicatively coupled to the controller and to the flexible I/O circuitry, wherein the signal processing resource is configured to offload at least one signal-processing task relating to the first signal from the controller.

Some implementations relate to a control system comprising: a controller to receive signals and data from at least one connected device in a dynamic environment; flexible input/output (I/O) circuitry communicatively coupled to the controller and to the at least one connected device to transform at least one first signal of a first signaling type from a first connected device of the at least one connected device to a second signal of a second signaling type that is supported by the controller; and a signal processing resource communicatively coupled to the controller and to the flexible I/O circuitry, wherein the signal processing resource is configured to offload at least one signal-processing task from the controller relating to the second signal.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A depicts an example of a sensing and control system for a dynamic environment in which the control system comprises signal-processing-resource circuitry (SPRe circuitry) according to one inventive implementation.

FIG. 1B depicts an example of a sensing and control system for a dynamic environment that includes a plurality of devices communicatively coupled to a controller via flexible input/output circuitry and signal-processing-resource circuitry (SPRe circuitry).

FIG. 2 depicts further details of SPRe circuitry in the control system of FIG. 1A and FIG. 1B.

FIG. 3 depicts another example of SPRe circuitry that can be used in the control system of FIG. 1A and FIG. 1B.

FIG. 4 plots an actual response curve for a thermistor and a mathematical fit to the response curve.

FIG. 5A is a circuit schematic for a flexible input/output circuit of FIG. 1A and FIG. 1B that supports single-ended digital and analog signaling types as well as differential digital and analog signaling types.

FIG. 5B is a circuit schematic for a flexible input/output circuit of FIG. 1A and FIG. 1B that supports single-ended digital and analog signaling types as well as differential digital signaling types.

### DETAILED DESCRIPTION

### I. Overview

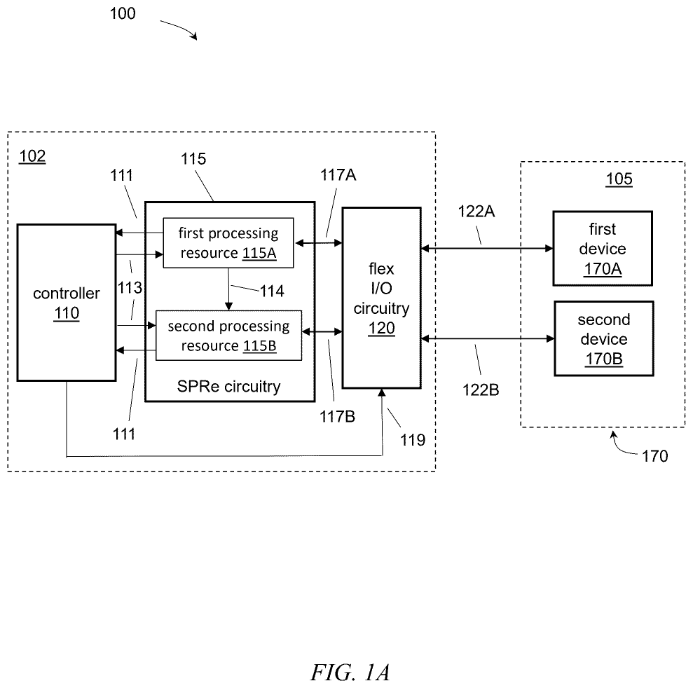

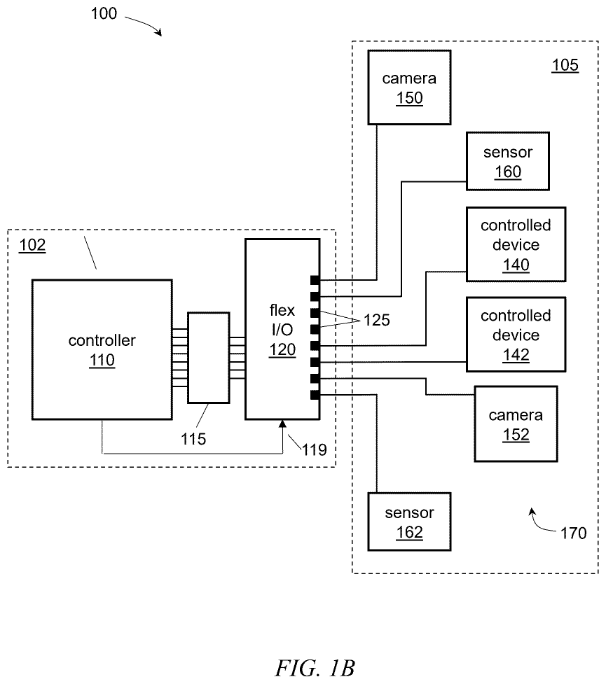

FIG. 1A depicts an example of a sensing and control system 100 that includes a control system 102 and a plurality of connected devices 170 in a dynamic environment 105 that are communicatively coupled to a controller 110 in the control system 102. In FIG. 1A, for simplicity and purposes of illustration the plurality of connected devices 170 is shown as including a first device 170A and a second device 170B; however, it should be appreciated that a variety of devices may be deployed in the dynamic environment 105 to sense one or more aspects of or conditions in the environment and or control one or more actions to be taken in the dynamic environment (as discussed in greater detail below in connection with FIG. 1B). As also depicted in FIG. 1A, the control system 102 includes the controller 110, signal processing resource circuitry (SPRe circuitry) 115, and flexible input/output circuitry (“flex I/O circuitry”) 120.

Regarding the controller 110 of the control system 102, example implementations of a controller 110 can be found in U.S. Pat. No. 9,459,607, entitled “Methods, Apparatus, and Systems for Monitoring and/or Controlling Dynamic Environments,” issued Oct. 4, 2016, which patent is incorporated herein by reference in its entirety. As noted in this patent, in general the controller 110 monitors and controls the dynamic environment 105, which has a plurality of conditions in response to which a plurality of actions are required. In one aspect, the controller 100 is configured to: 1) divide the plurality of conditions into multiple subsets including a first subset; 2) evaluate the first subset of the plurality of conditions by receiving at least one input signal 111 representing at least one monitored condition of the plurality of conditions and processing the at least one input signal so as to determine if at least one condition of the first subset is satisfied; and 3) provide first control information 113 representing at least one first action of the plurality of actions if the at least one condition of the first subset is satisfied. As shown in FIG. 1A and discussed further below, in one aspect the at least one input signal 111 may be provided to the controller 110 from one or more of multiple processing resources of the SPRe circuitry 115. Similarly, the first control information 113 provided by the controller 110 may serve as an input to one or more of the multiple processing resources of the SPRe circuitry 115.

The controller 110 can be implemented as a microprocessor, microcontroller, programmable logic controller, field-programmable gate array, digital signal processor, application specific integrated circuit, logic circuit, or some combination thereof. In some implementations, the controller 110 can be implemented as a networking component that generally manipulates a signal (e.g., an Ethernet PHY, a router, etc.). The controller 110 also may implement signal isolation functionality (e.g., with magnetics, capacitive coupling, and/or opto-isolators—not shown).

Regarding the flexible input/output circuitry 120 of the control system 102, example implementations of flexible input/output circuitry 120 can be found in U.S. Pat. No. 11,182,326, entitled “Input/Output Apparatus and Methods for Monitoring and/or Controlling Dynamic Environments,” issued Nov. 23, 2021, which patent is incorporated herein by reference in its entirety. In general, the flexible input/output circuitry 120 is communicatively coupled to the controller 110 to configure and support a first input/output (I/O) signaling channel 122A to facilitate communication between the flexible input/output circuitry and a first device 170A of a plurality of devices 170 in the dynamic environment 105. The flexible input/output circuitry 120 also configures and supports a second input/output (I/O) signaling channel 122B to facilitate communication between the flexible input/output circuitry and a second device 170B of the plurality of devices 170 in the dynamic environment 105. In one aspect, the flexible input/output circuitry 120 dynamically configures each of the first I/O signaling channel 122A and the second I/O signaling channel 122B, based on at least one programming input 119 provided by the controller, to support transmission and/or reception of single-ended digital and analog signaling types and/or differential digital and analog signaling types. Although only two I/O signaling channels 122A and 122B are shown for simplicity in FIG. 1A, it should be appreciated that, as discussed in U.S. Pat. No. 11,182,326 and shown in FIG. 1B discussed below, the flexible input/output circuitry 120 may configure and support additional signaling channels to transmit and/or receive various analog and digital signal types.

The control system 102 shown in FIG. 1A also includes signal processing resource (SPRe) circuitry 115, communicatively coupled to and disposed between the controller 110 and the flexible input/output circuitry 120. As discussed in greater detail below, examples of signal processing and signal generation functionality that may be performed by the SPRe circuitry 115 in connection with signals or other information received from the controller 110, as well as signals or other information received from the flexible input/output circuitry 120, include but are not limited to: analog filtering; digital filtering; frequency and/or phase detection; normalization, scaling and/or other transformation (e.g., via one or more look-up tables or “LUTs”); digital signal generation; and analog signal generation.

In various aspects, SPRe circuitry 115 can be particularly configured by the controller 110 to perform a variety of signal processing and/or signal generation functionality; further, the controller 110 may also provide one or more signals to trigger operation of the SPRe circuitry 115 or be themselves processed by the SPRe circuitry 115 (e.g., for transmission ultimately to one or more devices 170 in the dynamic environment 105, via the flexible input/output circuitry 120). Likewise, the SPRe circuitry 115 may receive one or more signals from the flexible input/output circuitry 120 (which signals are provided in the first instance to the flexible input/output circuitry by one or more devices 170 in the dynamic environment 105); the SPRe circuitry 115 can process the one or more signals received from the flexible input/output circuitry 120 (in some instances based at least in part on particular configuration of the SPRe circuitry 115 by the controller 110) and in turn transmit the processed signal(s) to the controller 110.

As shown in FIG. 1A, the SPRe circuitry 115 includes a first processing resource 115A to process a first signal 117A transmitted to or received from the first I/O signaling channel 122A via the flexible input/output circuitry 120. The SPRe circuitry 115 further includes a second processing resource 115B to process a second signal 117B transmitted to or received from the first I/O signaling channel 122A or the second I/O signaling channel 122B via the flexible input/output circuitry 120. Each of the processing resources 115A and 115B of the SPRe circuitry 115 may be particularly configured at a given time (e.g., by the controller 110) to perform some type of signal processing or signal generation on a signal provided to the SPRe circuitry by either the controller 110 or the flexible input/output circuitry 120.

As also shown in FIG. 1A, one or both of the first processing resource 115A and the second processing resource 115B of the SPRe circuitry 115 provides to the controller 110 the at least one input signal 111 representing the at least one monitored condition of the plurality of conditions in the dynamic environment 105. In another aspect, at least one of the first processing resource 115A or the second processing resource 115B receives from the controller 110 the first control information 113 representing the at least one first action of the plurality of actions and processes at least one of the first signal 117A or the second signal 117B based at least in part on the received first control information 113. As noted above, it should be appreciated that the first control information 113 provided by the controller 110 may include configuration information for a given processing resource (e.g., to configure the given processing resource to perform a particular signal processing or signal generation function); additionally or alternatively, the first control information 113 provided by the controller 110 may include one or more signals that are themselves to be processed by one or more processing resources of the SPRe circuitry or trigger operation of one or more processing resources (e.g., in some instances pursuant to configuration information previously provided to the processing resource(s)).

In yet another aspect of the SPRe circuitry 115 shown in FIG. 1A, the second processing resource 115B receives at least one SPRe control signal 114 (also referred to hereing as a “master” signal) from the first processing resource 115A and processes the second signal 117B based at least in part on the SPRe control signal 114. In various aspects, the second processing resource 115B may use the first control information 113 and the SPRe control signal 114 for configuration of signal processing and/or signal generation functionality, use one of the first control information 113 and the SPRe control signal 114 for configuration and the other for triggering operation of the second processing resource 115B (e.g., first control information 113 for configuration and SPRe control signal 114 for triggering operation), or use only the SPRe control signal 114 for at least one of configuration or triggering operation of the second processing resource 115B.

Thus, it may be appreciated from the foregoing that a first processing resource of the SPRe circuitry 115 may be configured by the controller 110 for a first type of signal processing or signal generation on a first signal (received from the controller 110 or from the flexible input/output circuitry 120), and a second processing resource of the SPRe circuitry 115 may be configured by the controller 110 for a second type of signal processing or signal generation on the first signal and/or a second signal received from the controller 110 or the flexible input/output circuitry 120. Furthermore, the first processing resource of the SPRe circuitry 115 may alternatively or additionally configure and/or trigger operation of the second processing resource of the SPRe circuitry 115 to perform the second type of signal processing or signal generation or yet another type of signal processing or signal generation on the first signal, the second signal, and/or a third signal received from the controller(s) of the flexible input/output circuit.

In view of the foregoing, it should be appreciated that the respective processing resources of the SPRe circuitry 115 shown in FIG. 1A may be flexibly and dynamically configured (and reconfigured over time) to perform some type of signal processing and/or signal generation in connection with “outbound” signals (from the controller 110 to the SPRe circuitry 115, then to the flexible input/output circuitry 120, then to the one or more devices 170 in the dynamic environment 105) as well as “inbound” signals (from the one or more devices 170 in the dynamic environment 105 to the controller 110, via the flexible input/output circuitry 120 and the SPRe circuitry 115). Additionally, it should be appreciated that at least a first processing resource of the SPRe circuitry 115 may communicate directly with one or more other processing resources of the SPRe circuitry 115 to configure and/or trigger operation of the one or more other processing resources, in some instances based at least in part on the processing or generation of a signal by the first processing resource. In this manner, multiple processing resources of the SPRe circuitry 115 may be employed in tandem (e.g., concurrently and/or sequentially, as in a “cascade” of events and actions) to perform corresponding types of signal processing and/or signal generation with little to no intervention or configuration by the controller 110 (or any significant use of processing bandwidth of the controller 110).

The foregoing concept of one processing resource of the SPRe circuitry 115 being capable of dynamically configuring and/or triggering operation of one or more other processing resources of the SPRe circuitry 115 is referred to herein as “cross-communication between multiple processing resources.” The SPRe circuitry 115 can thereby take on signal processing tasks that would otherwise by handled by the controller 110, freeing up the controller 110 to attend to other system management and control tasks. In various aspects, the offloading of signal processing bandwidth from controller 110 to the SPRe circuitry 115 and the speed of the SPRe circuitry 115 can significantly decrease the overall latency of the sensing and control system 100.

The inventors have further recognized and appreciated that this concept of cross-communication between multiple processing resources of the SPRe circuitry 115 can be employed to dynamically reconfigure respective processing resources of the SPRe circuitry such that a given processing resource acts as a “master” processing resource and one or more other processing resources act as a “slave” processing resource at a given time—and then the respective roles of master and slave processing resources can be reconfigured at a later time (such that a master becomes a slave or vice versa). In one example discussed further below, a first processing resource of the SPRe circuitry 115 is configured to process one or more incoming signals, via the flexible input/output circuitry 120, from a first device 170A (e.g., a first stepper motor) in the dynamic environment 105. In this example, the first stepper motor provides a signal 122A to the flexible input/output circuitry 120 upon completion of a particular task or reaching a certain state (e.g., completion of N shaft rotations). When the first processing resource 115A of the SPRe circuitry 115 receives the signal provided by the first stepper motor indicating completion of the particular task/reaching a certain state, the first processing resource triggers operation of the second processing resource 115B, which is configured to provide a signal 117B to the flexible input/output circuitry 120 and in turn a signal 122B to a second device 170B (e.g., a second stepper motor) in the dynamic environment 105 to operate in a particular manner (e.g., ramp up the motor speed to 2000 RPM). In this manner, the first processing resource 115A is a “master” and the second processing resource 115B is a “slave” in that the second stepper motor is only operated after the first stepper motor has completed a particular task or reached a certain state.

At a later time, one or both of the first and second processing resources of the SPRe circuitry 115 may be reconfigured (e.g., by the controller 110) such that the second processing resource expects an input from the second stepper motor and/or another device in the dynamic environment 105, and on receipt of this new input triggers operation of the first processing resource or yet another processing resource to provide a signal to the first stepper motor or yet another device in the dynamic environment—in this manner, the second processing resource 115B becomes a “master” that reconfigures and/or triggers operation of another processing resource of the SPRe circuitry 115.

Thus, it may be readily appreciated that the SPRe circuitry 115 provides a sophisticated architecture with rich functionality to augment control systems for dynamic environments by providing flexible, dynamic, bi-directional and reconfigurable signal processing and signal generation.

In some implementations as described in further detail below, the respective processing resources of the SPRe circuitry can be implemented, at least in part, with dedicated circuitry (e.g., logic circuitry, code implemented on gates of a field-programmable gate array (FPGA), an application-specific integrated circuit (ASIC), universal asynchronous receiver transmitter (UART), digital signal processor (DSP), etc., or some combination of such dedicated circuitry), so that the SPRe circuitry can perform signal processing and/or signal generation tasks faster than the tasks would be performed by the controller(s) to which the SPRe circuitry is coupled.

FIG. 1B depicts further details of the sensing and control system 100 shown in FIG. 1A, and in particular, the plurality of connected devices 170; these devices 170 can include any subset or combination of one or more controlled devices 140, 142 (e.g., motor(s), conveyor belt(s), robotic arm(s), lighting equipment, a combination of such devices), one or more imaging devices 150, 152 (e.g., photo camera(s), CCD imaging array(s), CMOS imaging array(s), a combination of such devices), and one or more sensors 160, 162 (e.g., temperature sensor(s), counter(s), rotary encoder(s), tachometer(s), pressure sensor(s), etc., a combination of such devices). One or more of the connected devices 170 can be controlled by the controller 110 (e.g., a controlled device 140 or imaging device 150 responds to a control signal transmitted by the controller 110 to the controlled device). Additionally, the controller 110 can receive, and may or may not respond to, information provided in signals transmitted from one or more of the connected devices 170.

As noted above, the flexible I/O circuitry 120 facilitates communications between the controller 110 and connected devices 170 (e.g., one or more controlled devices 140, 142, one or more cameras 150, 152, and/or one or more sensor 160, 162) that operate in the dynamic environment 105. As shown in FIG. 1B, the flexible I/O circuitry 120 may include a plurality of terminals 125 (connecting to signaling channels in the flexible I/O circuitry 120) that each can connect to a device in the dynamic environment 105. Each of the signaling channels can be configured by the controller 110 (e.g., via the programming signal 119) to send signals from a corresponding terminal 125 and/or receive signals at the corresponding terminal 125. Further, each signaling channel can be configured by the controller 110 to support more than one type of signaling protocol (e.g., current-sourced analog signaling or differential analog signaling, single-ended digital signaling or differential digital signaling, etc.). A signaling channel can comprise a plurality of circuit components in the flexible I/O circuitry 120 and one or two links (e.g., wires) that connect to a terminal 125 to carry a signal that encodes information and/or at least one command. By using the flexible I/O circuitry 120, the amount of interface components and cabling between the controller 110 and the connected devices 170 in the dynamic environment 105 can be significantly reduced compared to conventional control systems.

Communication between the flexible I/O circuitry 120 (and/or controller 110) and a connected device in the dynamic environment 105 over a signaling channel can be in a half-duplex mode for some of the connected devices 170 that support half-duplex communications. In some implementations, full duplex communication can be established with a connected device that supports full duplex communication by connecting two signaling channels from the flexible I/O circuitry 120 to the connected device and using one signaling channel as a downlink to the connected device (from the controller 110 to the connected device) and the other signaling channel as an uplink to transmit data, for example, to the controller 110. In some instances, a signaling channel of the flexible I/O circuitry 120 may be configured to implement more than one type of signaling at the same time (e.g., providing a current through a signaling channel while sampling the voltage on the same channel, such as when providing a current to a thermistor and reporting the temperature from a thermistor).

### II. Signal-Processing-Resource Circuitry Coupled to the Controller and Flex I/O Circuitry

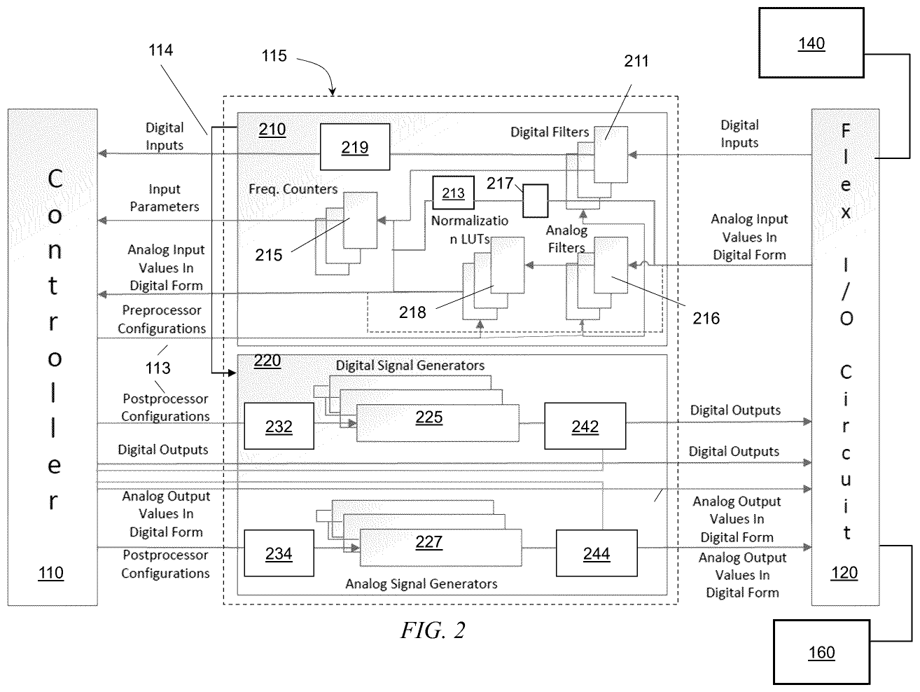

FIG. 2 depicts further details of one nonlimiting example of SPRe circuitry 115 that can be communicatively coupled to the controller 110 and to the flexible I/O circuitry 120, according to one inventive implementation. The example of FIG. 2 shows SPRe circuitry that includes two processing resources that are respectively dedicated to a particular direction of signal propagation. It should be appreciated however that, as discussed above, a given processing resource of the SPRe circuitry 115 need not be limited to processing signals propagating in a given direction within the sensing and control system, and that the particular example discussed below in connection with FIG. 2 is provided primarily for purposes of illustrating some of the salient concepts underlying the signal processing and signal generation functionality of the SPRe circuitry 115.

More specifically, the SPRe circuitry 115 shown in FIG. 2 comprises a preprocessor 210 and a postprocessor 220, for at least one signaling channel of the flexible I/O circuitry 120 that is used to communicate with one or more connected devices 170 (e.g., one or more controlled devices, sensors, and/or cameras) in the dynamic environment 105. Generally, the preprocessor 210 can implement functionality to process signals coming from the flexible I/O circuitry 120 on a signaling channel (e.g., data from a sensor 160 connected to the signaling channel) and then transmit results of the processed signals to the controller 110. The postprocessor 220 can implement functionality to process signals coming from the controller 110 and then transmit results of the processed signals to the flexible I/O circuitry 120 (e.g., output a waveform to control a motor). The flexible I/O circuitry 120 can, in turn, transmit the results of the processed signals to the controlled device 140 (using a signaling type supported by the controlled device 140) via the corresponding signaling channel.

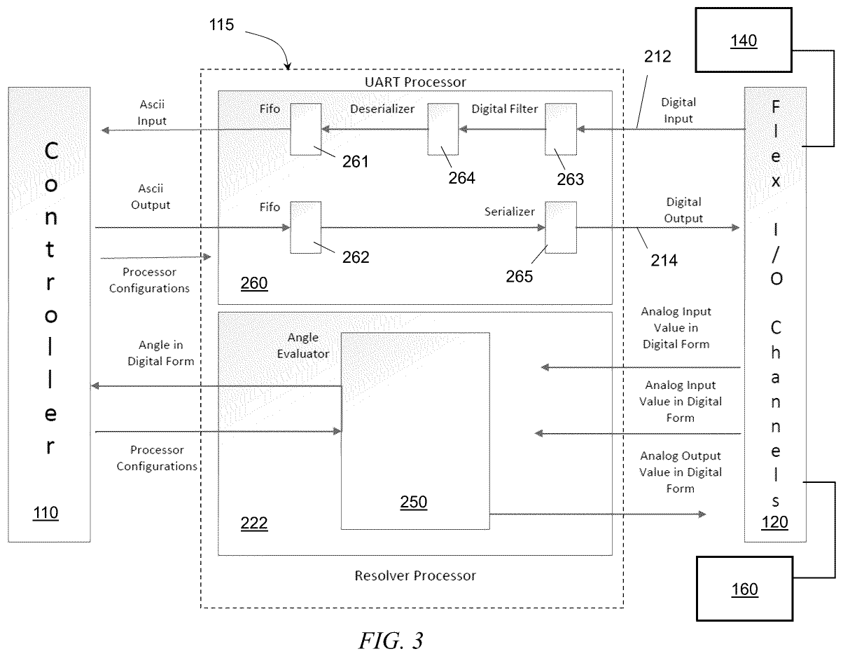

The drawing of FIG. 2 depicts a preprocessor 210 and a postprocessor 220 for only one flexible I/O channel. In an example implementation, the flexible I/O circuitry 120 can have up to eight or sixteen flexible I/O signaling channels, each for communicating with one or more connected devices 170 in the dynamic environment 105, and each signaling channel can comprise at least one preprocessor 210 (and its associated hardware and software as depicted in FIG. 2) and/or at least one postprocessor 220 (and its associated hardware and software and its associated hardware and software as depicted in FIG. 2). However, the flexible I/O circuitry 120 can be implemented with more or fewer flexible I/O channels, at least some of which may include or may communicate with a preprocessor 210 and/or postprocessor 220. The SPRe circuitry 115 can be implemented with other processors (which may perform both preprocessing and postprocessing functionalities), as depicted in FIG. 3.

Referring again to FIG. 2, the SPRe circuitry 115 can be implemented, at least in part, with digital and/or analog circuit components (e.g., frequency counters, digital filters, digital signal generators, analog filters, analog signal generators, etc. or some combination thereof). For example, the preprocessor 210 can include a frequency counter to determine the frequency of a received digital or analog signal.

In some cases, the SPRe circuitry 115 can be implemented additionally or alternatively, at least in part, with machine code that executes on circuitry of at least one processor. Such a processor can be a microprocessor, microcontroller, field-programmable gate array (FPGA), a programmable logic controller (PLC), application-specific integrated circuit (ASIC), digital signal processor (DSP), custom programmable digital and/or analog circuitry, etc., or some combination thereof. For example, machine code executing on a digital signal processor can perform a filtering function on a sampled analog signal received from the flexible I/O circuitry 120.

By implementing the SPRe circuitry 115 with dedicated circuitry, the SPRe circuitry can perform signal-processing tasks more quickly than the controller 110 would be able to process them. As such, the SPRe circuitry can offload processing tasks from the controller 110 and additionally increase processing speed of the offloaded tasks.

In some cases, one or more processors that is/are used to implement a preprocessor or postprocessor of the SPRe circuitry 115 can be shared, i.e., a selected processor may be adapted to perform some of the functionality of the SPRe circuitry, some of the functionality of the controller 110, and/or some of the functionality of the flexible I/O circuitry 120. In some implementations, functionality of the SPRe circuitry 115 can be implemented in part by code executing on one or more processors of the controller 110 and in part by code executing on one or more processors of the flexible I/O circuitry 120.

### II. A. Preprocessor

The preprocessor 210 can include one or more frequency counters 215, one or more digital filters 211, one or more analog filters 216, one or more prescalers 219, and/or one or more look-up tables (LUTs) 218 for operating on signals received from the flexible I/O circuitry 120. The preprocessor 210 can also receive digital signals from the flexible I/O circuitry 120 which may or may not be processed by the preprocessor 210. Unprocessed signals can be passed on to the controller 110 as digital inputs for further processing by the controller (indicated by the dashed signal path in the preprocessor of FIG. 2). Results of processed signals (e.g., a filtered version of the received signal or a value computed based on the received signal) can be transmitted to the controller 110, relieving the controller of the corresponding signal-processing task (e.g., digital filtering, computation) performed by the preprocessor 210.

With reference for the moment to FIG. 1B, digital signals received by the preprocessor can originate from one or more of the connected devices 170 (e.g., sensor 160, 162, camera 150, 152, or controlled device 140, 142) in the dynamic environment 105. A received digital signal may be (1) in its original form as transmitted by the connected device 140 and passed on by the flexible I/O circuitry 120 or (2) converted (by the flexible I/O circuitry 120) from a first signaling type (e.g., analog, single ended) received by the flexible I/O circuitry 120 to a different, second signaling type (e.g., digital TTL signal) that is provided to the preprocessor 210.

Referring again to FIG. 2, in some cases, a digital signal received by the preprocessor 210 can be filtered by one or more digital filters 211 implemented in the preprocessor 210. Additionally, or alternatively, a received digital signal can be provided to a frequency counter 215 or phase detector (not shown in FIG. 2) implemented in the preprocessor 210 for detecting at least one of a frequency, changes in frequency, a phase, or changes in phase of the digital signal. Detection of changes in frequency and/or phase may be for purposes of signal decoding. Outputs from the frequency counter and phase detector can be provided to the controller 110 as input parameters for further processing by the controller 110.

Implementing digital filtering, frequency detection, and/or phase detection with dedicated circuitry between the flexible I/O circuitry 120 and the controller 110 can offload such signal-processing tasks from the controller 110 and make available more processing time at the controller 110 for attending to overall system control tasks. In addition to speeding up processing of received signals from the flexible I/O circuitry 120 and reducing the workload on the controller 110, the precision of the signal processing performed by the preprocessor 210 can be better (for high frequency signals for example) than the precision that would be achieved with the controller 110 when the controller is tasked with other signal-processing, command, and control actions.

As mentioned above, the preprocessor 210 can receive sampled, digitized, analog signals (indicated in FIG. 2 as “analog input values in digital form”) from the flexible I/O circuitry 120. The received digitized analog signals may or may not be filtered by at least one “analog” filter 216 implemented in the preprocessor 210 before forwarding the filtered or unfiltered digitized analog signals to the controller 110 as analog inputs for further processing by the controller. The analog filter 216 can be implemented in software code to operate on a digital signal representation of an analog signal received by the flexible I/O circuitry 120 from one of the connected devices 170.

According to some implementations, the flexible I/O circuitry 120 can digitize one or more analog signals (such as analog waveforms) and/or one or more analog values (such as voltage or current readings) received from a connected device 140 in the dynamic environment 105 and provide one or more corresponding digitized representations of the analog signal(s) and/or analog value(s) to the preprocessor 210 (indicated as Analog Input Values in Digital Form), as depicted in the example implementations of FIG. 2 and FIG. 3. In such cases, the “analog filters” can be implemented in code to operate on the digitized signal. For example, an analog filter may compute a running average of received digital values, where the average is based on the N most recently received digital values (where Nis a positive integer). Other functionalities can be implemented with the “analog filters” (e.g., threshold detection, differentiation, rejection of values beyond an allowable excursion from a running average, hysteresis, etc.). The connected device 140 can communicatively couple to the flexible I/O circuitry 120 with more than one signaling channel to communicate more than one analog signal and/or more than one analog value.

Components of the preprocessor 210 (and postprocessor 220) can be initialized by the controller 110 when placed into service with configuration values (indicated as Processor Configurations in FIG. 2 and FIG. 3). Some configuration values that can be issued by the controller 110 to configure the “analog filter” 216 include a time constant τ, an excursion value E, a threshold value T, and hysteresis H. The time constant r can be expressed in time units (e.g., digital clock cycles) and can span a time for which input samples will be averaged to produce running averages of the input samples. The running averages can be provided to the controller 110 as a response to queries from the controller 110 for the detected input voltage or current on the corresponding channel of the flexible I/O circuitry 120. The time constant value impacts the weight each new sample has on the running average value. The time constant can be implemented with a digital counter of the analog filter 216 whose value can be updated as frequently as every sample time (e.g., every 8 μs for some implementations of the control system 102).

The excursion E can be a percentage of full scale that a new sample is permitted to deviate from the current running average value to be included in the running total. Values that exceed the excursion limit can be rejected by the preprocessor 210. Selecting the excursion value E facilitates adjustment of rejection of short transient noise spikes.

The threshold value T can be implemented as a value that, when crossed, triggers an interrupt-driven delivery by the preprocessor 210 of an input value to the controller 110. The interrupt-driven delivery can cause the controller 110 to take an action (which can be immediate) in response to the detected crossing of the threshold value T by the preprocessor.

Hysteresis H can represent an excursion from a last running average reported via an interrupt (in response to a threshold crossing, for example) before a new interrupt-driven delivery will be initiated by the preprocessor 210. For example, if a running average value is typically about 50 and the threshold T is set at 80, a temporary increase of the running average to about 90 will be reported by the preprocessor 210 to the controller 110 with an interrupt-driven delivery. If the hysteresis H is set at 30, then the current running average (about 90 in this example) must change by at least 30 before the new current running average is reported by the preprocessor 210 to the controller 110 with an interrupt-driven delivery.

In some implementations, the flexible I/O circuitry 120 can provide raw analog signals to the preprocessor 210 and the analog filters 216 can be implemented with circuit components (e.g., resistors, capacitors, inductors, op-amps, etc.) to form any suitable analog filter or analog functionality 217 (e.g., integrator, differentiator, threshold detector, etc.). Analog-to-digital conversion 213 can then be implemented after the analog filters (e.g., with A/D converters in the preprocessor 210), before the filtered signals are provided to the controller 110.

In some cases, outputs from the analog filters (or A/D converters after the analog filters), or outputs received directly from the flexible I/O circuitry 120 can be provided to one or more look-up-tables (LUTs) 218 for further signal processing. A LUT 218 may use each received value to address an entry in the table and retrieve a corresponding value that is passed on to the controller 110 instead of or in addition to the value received by the LUT 218. The corresponding value that is passed to the controller can provide a more accurate representation of a physical parameter in the dynamic environment 105 than the received value. The corresponding value may correct for system and/or device errors, such as a nonlinear response by a device. Alternatively, outputs from the analog filters (or A/D converters) can be provided directly to the controller 110 for further processing.

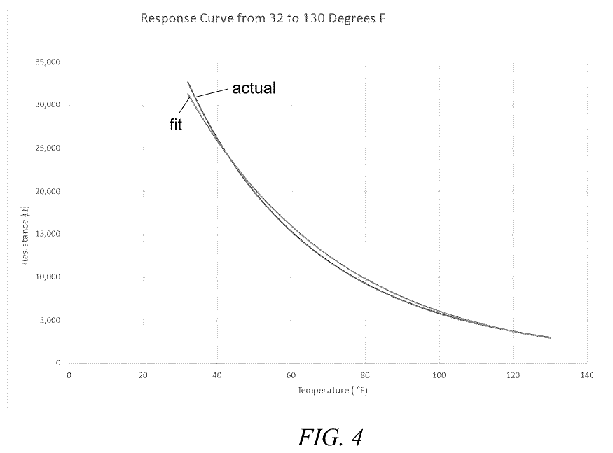

An example application that can benefit from the use of a LUT 218 is one in which a sensor 160 comprises a thermistor to sense a temperature in the dynamic environment 105. Thermistors typically have non-linear behavior (resistance as a function of temperature), which is shown in FIG. 4 for a typical thermistor (curve labeled “actual”). Although such a curve can be approximated by a mathematical function (curve labeled “fit”), the mathematical approximation can result in up to 7% error in temperature when interpreting resistance values sensed by the thermistor. The use of a LUT 218 that maps detected resistance values to temperatures according to the actual response curve of the thermistor can result in significantly lower errors in sensed temperatures (e.g., sensing errors less than 0.5 degree Fahrenheit over the full working range of the thermistor compared to several degrees over a portion of the thermistor's full working range which may be up to 200 degrees Fahrenheit or more).

In some cases, the preprocessor 210 can include one or more pre-scalers 219 that operate on data received from the flexible I/O circuitry 120. A pre-scaler 219 may rescale the received data before sending the rescaled data to the controller 110. The rescaling can alter the data so that it covers a full range of data values supported by the controller 110.

Components of the preprocessor 210 can be configured by the controller 110 at any time via one or more preprocessor configuration communication lines, which are depicted in FIG. 2 as connecting to the LUTs 218, analog filters 216, and digital filters 211. For example, entries in the LUTs 218 can be written and/or rewritten by the controller 110 which can transmit new configuration data (new LUT entries) via the preprocessor configuration line(s). Filter settings and other configuration values can also be set and revised by transmitting data via the preprocessor configuration line(s).

The functionality of the preprocessor 210 may be implemented in other ways, as depicted in FIG. 3 and described further below. One or more preprocessors 210 can be assigned by the controller 110 to a signaling channel of flexible I/O circuitry 120. Preprocessors 210 of different types (e.g., a type depicted in FIG. 2 and a type depicted in FIG. 3) can be assigned to a single signaling channel if the functionality of the signaling channel changes during operation of the control system 102. For example, the controller 110 may reassign SPRe circuitry such that a first SPRe circuitry 115 assigned to a signaling channel for a first period of time during operation of the control system 100, and then the controller can remove the assigned first SPRe circuitry 115 and assign a second SPRe circuitry 115 having a different preprocessor type to the signaling channel. There can be fewer, the same, or more preprocessors 210 in a control system 102 that are available for assignment to signaling channels of the flexible I/O circuitry 120 than there are signaling channels in the flexible I/O circuitry 120.

### II. B. Postprocessor

Referring again to FIG. 2, the postprocessor 220 can receive digital outputs or “analog” outputs (in digital form) from the controller 110, may process the digital outputs or analog outputs, and provide the processed and/or unprocessed digital outputs or analog outputs to the flexible I/O circuitry 120. The flexible I/O circuitry 120 can then pass the outputs on to one or more connected devices 170 in the dynamic environment 105. Postprocessing capability for “analog” signaling types and digital signaling types can be present for each channel of the flexible I/O circuitry 120 and can be selected and/or configured at any time via the controller 110 (e.g., based upon user input when initially configuring the control system 102 to operate with connected devices 170 in the dynamic environment 105 or based upon information received via the flexible I/O circuitry 120 from at least one device in the dynamic environment 105).

In some cases, the received analog output from the controller 110 can be received from the controller as a digital signal that is intended to be converted to an analog signal (e.g., by a digital-to-analog converter) prior to transmission from the flexible I/O circuitry 120, so that an analog signal is delivered to a device in the dynamic environment 105 that is communicatively coupled to the signaling channel. The D/A conversion may be done at the flexible I/O circuitry 120, for example.

For the example implementation of FIG. 2, the postprocessor 220 can include one or more digital signal generators 225 and one or more “analog” signal generators 227 along with input data buffers 232, 234 and output data buffers 242, 244. The input data buffers 232, 234 that are arranged to receive information from the controller 110 can allow multiple commands from the controller 110 to be queued and thereby free the controller 110 to attend to other tasks. The input data buffers 232, 234 can be first-in-first-out (FIFO) data buffers, for example.

The output data buffers 242, 244 are arranged to pass information to the flexible I/O circuitry 120 and can also be FIFO data buffers. The output data buffers 242, 244 can allow queuing of generated signals from the digital signal generator(s) and/or analog signal generator(s). These buffers can also be used as completion buffers that communicate with the controller 110 to notify the controller when a particular signal is being sent (or has been sent) to the flexible I/O circuitry 120.

The postprocessor 220 also includes at least a first signal path for digital outputs that are provided to the flexible I/O circuitry 120 and/or at least a second signal path for analog outputs that are provided to the flexible I/O circuitry 120. Signal buffering may or may not be used on these first and second signal paths. Signal processing (e.g., filtering) may or may not be used on these first and second signal paths. In some cases, a digital signal and/or analog signal from the controller 110 can be passed through the postprocessor 220 and provided unprocessed to the flexible I/O circuitry 120.

A digital signal generator 225 can be configured to output binary waveforms that are passed to the flexible I/O circuitry 120 and then sent to at least one connected device 140 in the dynamic environment 105. An example binary waveform can be a waveform that is used to control a stepper motor or other servo motor, for example. Parameters for a digital waveform can be specified by the controller 110 as postprocessor configurations that can be queued in the input data buffer 232 and then sent to the digital signal generator 225. Such postprocessor configurations can include the features of the digital waveform to be generated (e.g., condition on which signal generation should start, frequency, start phase, end phase, duration, amplitude, duty cycle, rate of change of the waveform from a starting state to a final state, condition on which signal generation should terminate). In some cases, a digital signal generator 225 can be implemented with an FPGA, DSP, and/or memory and logic gates to access the memory for example.

An “analog” signal generator 227 can be configured to output a digital signal that is passed to the flexible I/O circuitry 120, converted to an analog signal at some point after being generated by the analog signal generator 227, and sent to at least one device 140 in the dynamic environment 105. The digital signal output by the analog signal generator can comprise a sequence of analog signal values (computed or generated by the postprocessor 220) that are each represented digitally in the signal sent to the flexible I/O circuitry 120. Conversion to an analog waveform may be done by the flexible I/O circuitry 120 or by a D/A converter prior to the flexible I/O circuitry 120. Example analog waveforms (after D/A conversion) can include a sinusoidal waveform, a triangular or saw-tooth waveform, a voltage or current ramp, etc. Parameters of the analog waveform (that will be output from the flexible I/O circuitry 120) can be specified by the controller 110 via postprocessor configurations that can be queued in the input data buffer 234 and then sent to the analog signal generator 227. Such postprocessor configurations can include the features of the analog waveform to be generated (e.g., condition on which signal generation should start, frequency, start phase, end phase, duration, amplitude, duty cycle, rate of change of the waveform from a starting state to a final state, condition on which signal generation should terminate). An analog signal generator 227 can be implemented with an FPGA, DSP, and/or memory and logic gates to access the memory for example.

In some implementations, the analog signal generator 227 can receive a certain number of input parameters from the controller 110 that determine the analog waveform and execute code on at least one processor to generate a corresponding digital signal, as described above, based on the received input parameters. The digital signal comprises a sequence of digitally-represented analog values and is output to the flexible I/O circuitry 120 from which the desired analog signal will be output. For example, one or more of the following parameters can be received, by the analog signal generator 227, as one or more configuration inputs from the controller 110.
Amplitude—specifies the amplitude of the generated analog waveform as percentage of full-scale capability of the output.
Period—specifies the time required for a full cycle of the desired waveform.
Start Phase—specifies the starting phase of the generated waveform. This can be implemented as a location (address or entry) in a LUT that stores a sequence of data values representative of a waveform. The address can output a value of the waveform (corresponding to the selected starting phase) at which the waveform should begin. The start phase may be designated by the user in terms of degrees, minutes, and seconds, or in some measure of radians (e.g., milliradians, microradians).
End Phase/Duration—specifies the ending phase of the generated waveform. This can be implemented as a location (address or entry) in the waveform LUT of the value at which the waveform should finish. This configuration input from the controller may include a duration code to designate a number of cycles of the waveform to output before terminating at the end phase or to designate continuous output of the waveform.
Wave Count—specifies the number of full cycles of the waveform to output.
Master Channel—specifies another channel of the flexible I/O circuitry 120 whose activity will enable action of the current channel of the flexible I/O circuitry 120 from which the signal is output. If specified, an event (e.g., threshold crossing, count value, etc.) on the master channel will activate output of the signal from the current channel (e.g., begin outputting the waveform at the specified start phase). The start phase can then dictate the relative phase of the output from the current channel with respect to the activating event on the master channel.
Waveform LUT—can specify which LUT from among multiple LUTs to use to generate a waveform. The postprocessor can include different LUTs (not shown in FIG. 2) for different types of waveforms (e.g., sinusoidal, square, triangular, etc.). Using an LUT to form the output waveform can provide greater accuracy in implementing sine waves (and other waveforms) than could otherwise be achieved without the LUT in addition to allowing other types of waveforms to be implemented rather easily. Further the LUTs can be rewritten with values representing any desired waveform.

Types of motors that can be controlled by the SPRe circuitry 115 include various types of servo motors as well as non-servo AC and DC motors. A servo motor refers to a motor implemented within a feedback control loop to achieve or maintain specified locations (rotation angles) or speeds. The motor inside the loop can be any controllable motor, such as a stepper motor or switched reluctance motor (SRM). Control of the motor can be by pulse-width modulation (PWM) or with pulse trains. Location and/or speed data to provide feedback information for the control loop can be provided from one or more encoders and/or resolvers mechanically coupled to the controlled motor or coupled to a rotating shaft driven by the motor. In some cases, position sensors and/or rotation sensors can be implemented with synchros (also referred to as selsyns), resolvers (4-pole synchros), or potentiometers.

Switched reluctance motors (SRMs) can be either outrunners (fixed magnets on the rotor surround the driven poles on the stator) or inrunners (where the static poles, stators, surround a static permanent magnet on an internal rotor). A switching network driving the stators of SRMs are frequently driven in quadrature so that the duty cycles of each phase can be driven at a convenient 50% duty cycle.

Functionality of a postprocessor 220 can be implemented in other ways, as depicted in FIG. 3 and described further below. One or more postprocessors 220 can be assigned via the controller 110 to a signaling channel of flexible I/O circuitry 120. Postprocessors 220 of different types (e.g., different types depicted in FIG. 2 and FIG. 3) can be assigned to a single signaling channel if the functionality of the signaling channel changes during operation of the control system 102. One way to change the type and/or functionality of a postprocessor 220 (and/or preprocessor 210) is through the configuration settings. For example, different configuration settings can be loaded into at least one buffer 232, 234 wherein each configuration setting can define a type and/or functionality of postprocessor 220. Configuration settings from the buffer(s) can be activated (loaded onto the SPRe 115 to configure the SPRe circuitry for operation) in real time by receipt of first control information 113 from the controller 110, and/or of a SPRe control signal 114 (also referred to as a “master signal”) from one of the processors of the SPRe circuitry to another of the processors of the SPRe circuitry. In this manner, different configuration settings can be toggled through during operation of the control system 100. There can be fewer, the same, or more postprocessors 220 in a control system 102 that are available for assignment to signaling channels of the flexible I/O circuitry 120 than there are signaling channels in the flexible I/O circuitry 120.

### II. B. Additional Implementations of Signal-Processing-Resource Circuitry

FIG. 3 depicts an additional example of SPRe circuitry 115 for at least one signaling channel of the flexible I/O circuitry 120 that can be implemented in the control system of FIG. 1B. In this implementation, the SPRe circuitry 115 comprises a universal asynchronous receiver transmitter (UART) processor 260 that can transform signaling types to allow communication between the controller 110 and one or more connected devices 170 in the dynamic environment 105 (e.g., serialize a control signal output as an ASCII signal in parallel format). The UART processor 260 can be implemented as a chip or implemented in machine code running on an FPGA, for example, and assigned to a signaling channel of the flexible I/O circuitry 120. The UART processor 260 can include FIFO data buffers 261, 262 on an input signal path 212 and output signal path 214, respectively, that communicatively couple the controller 110 and the flexible I/O circuitry 120. The UART processor can implement a digital filter 263 and deserializer 264 (for serial to parallel data transmission conversion) on the input signal path 212, and can further implement a serializer 265 (for parallel to serial data transmission conversion) on the output signal path 214. In this regard, the UART processor 260 implements both preprocessing and postprocessing functionality to offload signal-processing tasks from the controller 110.

The UART processor 260 can be reconfigured to handle transformations between more than two different signaling types, and the configuration of the UART processor for particular signaling types can be set with parameters transmitted from the controller 110 to the UART processor 260 as Processor Configurations, which are indicated in FIG. 3. Such configuration parameters can relate to the particular signaling types for which transformation occurs (e.g., baud rates, use of parity bits, start bits, stop bits, etc.)

The SPRe circuitry 115 can alternatively or additionally include a resolver processor 222 for controlling a motor, using a control loop for example, in the dynamic environment 105. The resolver processor 222 can include an angle evaluator 250 that is adapted to interpret two signals from a resolver (which may be implemented as a sensor 160 in the dynamic environment 105). The two signals from the resolver (sensor 160) can be sinusoidal analog signals having different phases that together encode a rotation angle of a shaft of the resolver, for example. The two signals can be received by the flexible I/O circuitry 120 as analog signals, converted to digital signals (by the flexible I/O circuitry 120 or A/D converters located between the flexible I/O circuitry 120 and the angle evaluator 250), and provided to the angle evaluator 250 for processing. The angle evaluator 250 can process the two received digital signals (e.g., determine a phase difference between the two signals) to determine an angle of the resolver's shaft. The resolver processor 222 can output the computed angular value of the resolver's shaft as a digital data value to the controller 110. The resolver processor 222 can further output a sequence of digital values (indicated in FIG. 3 as Analog Output Values in Digital Form) that is converted to an analog sinusoidal waveform (by the flexible I/O circuitry 120 or by a D/A converter located between the flexible I/O circuitry 120 and the angle evaluator 250). The analog waveform can be used to excite a resolver, for example. The resolver processor can be reconfigured to handle different types of resolvers, and the configuration of the resolver processor can be set with parameters transmitted to the resolver processor 222 from the controller 110 as Processor Configurations. Such configuration parameters might include frequencies and amplitudes of sinusoidal waveforms provided to and received from the resolver. According to some implementations, the resolver processor 222 and angle evaluator 250 can be implemented, at least in part, with machine code executing on at least one FPGA or other processing device.

### II. C. Additional Components of the Signal-Processing-Resource Circuitry

In some implementations, the preprocessor 210 and/or the postprocessor 220 can include additional or alternative circuit components. For example, the preprocessor 210 and/or the postprocessor 220 can include high-speed counters with or without compare functions. Use of high-speed counters and compare functionality can provide for signal generation (e.g., beginning, ending) by one signal generator to be contingent upon the status of another signal generator. Such contingent operation can support coordinated operation of multiple motors in the dynamic environment 105. Coordinated operation of motors may be used for coordinated multi-axis motion of machinery in the dynamic environment 105 (e.g., robotic arms, CNC machines, etc.).

The preprocessor 210 and/or the postprocessor 220 (or processor implementing one or both of preprocessor and postprocessor functionality) can also include dedicated comparators and channel memory. The dedicated comparators can detect critical changes of either or both analog and digital signals received from the flexible I/O circuitry 120 and activate particular entries on an event table of the controller 110. The event table can determine one or more actions to be taken in response to one or more detected conditions in the dynamic environment 105. The channel memory can be used for high-frequency sampling of incoming analog signals received from the flexible I/O circuitry 120.

Another component that can be included in the preprocessor 210 for each channel is a baud rate controller. This device can manage delivery of signal values to the channel at a prescribed baud rate and character set. The baud rate controller can adapt signaling to various communication protocols such as, but not limited to, CANBus, ProfiBus, or another protocol on top of RS485. One example of a device that can be used as a baud rate controller is the UART processor 260 depicted in FIG. 3.

In FIG. 2, a plurality of components is shown for several components of the preprocessor 210 and the postprocessor 220. There can be one or more components for each channel of the flexible I/O circuitry 120 and a component can be selected based upon a configuration setting used to configure the SPRe circuitry 115 for operation. For example, the SPRe circuitry 115 can include different types of digital filters 211. The type of digital filter 211 can be selected for the SPRe circuitry 115 by a “filter” configuration setting. The configuration setting to select a component (and establish a mode of operation of the SPRe circuitry 115) may be instantiated by the controller 110 (e.g., at start-up time or on-the-fly during system operation). As described further below, the configuration setting to select a component can also be instantiated by another SPRe circuit 115 via the master input line 205.

In some cases, communication can be provided between SPRe circuits 115 (affecting operation of their components) across different signaling channels of the flex I/O circuitry 120. For example, a first SPRe circuit 115 assigned to a first signaling channel of the flex I/O circuitry can communicate with a second SPRe circuit 115 assigned to a second signaling channel of the flex I/O circuitry 120. The first SPRe circuit 115 can indicate, for example, a signal-processing task status (e.g., idle, start, running, complete) of the first SPRe circuit 115. In one example, the status(es) of the digital signal generators 225 and/or analog signal generators 227 can be communicated across signaling channels to notify another SPRe circuit 115 when signal generation has started and/or stopped. Such cross-channel communication can allow operating scenarios where one signal generator for one signaling channel of the flexible I/O circuitry 120 may only be allowed to initiate signal generation after completion of signal generation by another signal generator for another signaling channel in the postprocessor 220. Cross-channel communication can also allow operating scenarios where signal generation is to be synchronized and occur simultaneously for two or more signaling channels. Alternatively, or additionally, at least some of the components of a SPRe circuit 115 can communicate directly with the controller 110 (communication lines not shown in FIG. 2) to notify the controller 110 of the component's operational status and/or receive configuration settings from the controller directly. Further, any of the preprocessor configuration and postprocessor configuration lines can include FIFO buffers to queue configuration settings sent to one or more components connected to the configuration line. Advancement of these FIFOs (and other FIFOs described above) can be dependent on the status of other channels of the flexible I/O circuitry 120, states in code (e.g., states in a SCORE program) that are executing on one or more processors of the control system 102, and/or conditions occurring with the machine being controlled and/or monitored in the dynamic environment 105.

In some cases, SPRe circuitry 115 may involve more than two links to carry signals and information between one of the connected devices 170 and the SPRe circuitry 115. An example of this is shown in FIG. 3 for the resolver processor 222 (e.g., three links for the resolver to receive two analog signals and output one analog signal to excite the resolver). In some implementations, more than one signaling channel of the flexible I/O circuitry 120 can be connected to a single connected device to establish more than two links between a connected device and the SPRe circuitry 115 and form a “signaling channel” for the connected device. In some cases, the flexible I/O circuitry 120 can be modified to add additional signal paths for each signaling channel, and terminals 125 of the flexible I/O circuitry 120 can, for example, comprise multiwire terminals that include more than two wires for carrying information and/or control signals. Additional signal paths can be added to each signaling channel by replicating circuitry used for existing signal paths in the flexible I/O circuitry 120. Alternatively, a single signaling channel can be time-multiplexed to establish two links on the single signaling channel.

### III. Signal Negotiations

According to some implementations, the control system 102 is capable of signal negotiations and renegotiations with connected devices 170 in the dynamic environment 105. For example, the controller 110 may first communicate with a device 140 in the dynamic environment 105 according to a default communication protocol that uses a first signaling type. Once communication is established, the device 140 may signal to the controller 110 a preferred signaling type that is different from the default signaling type. The controller 110 can then reconfigure the signaling channel, by changing configuration settings in the flexible I/O circuitry 120, to continue communication with the device 140 according to the preferred signaling type.

### IV. Flexible Input/Output Circuitry

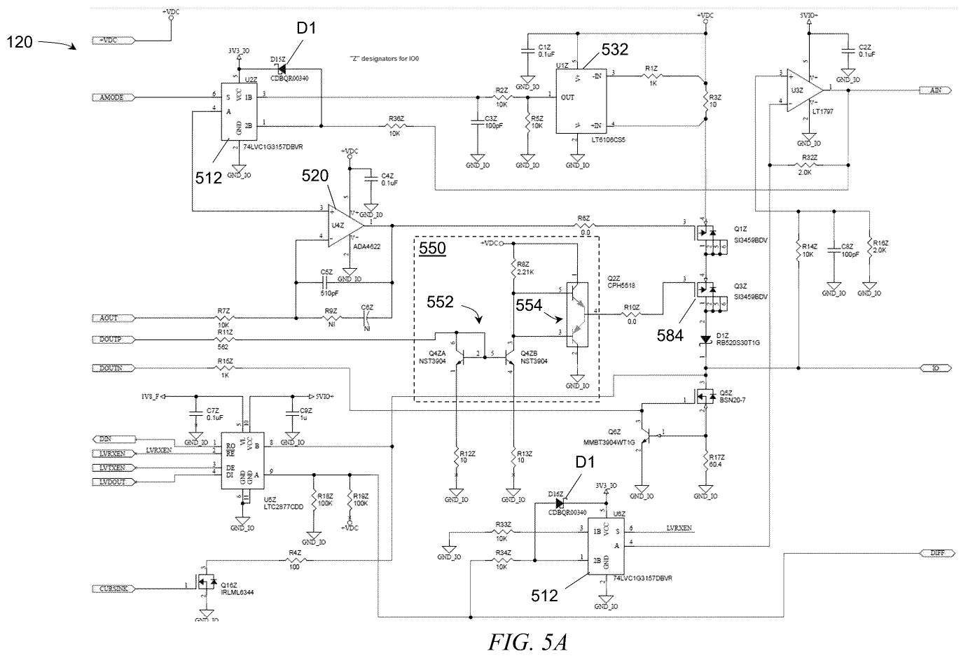

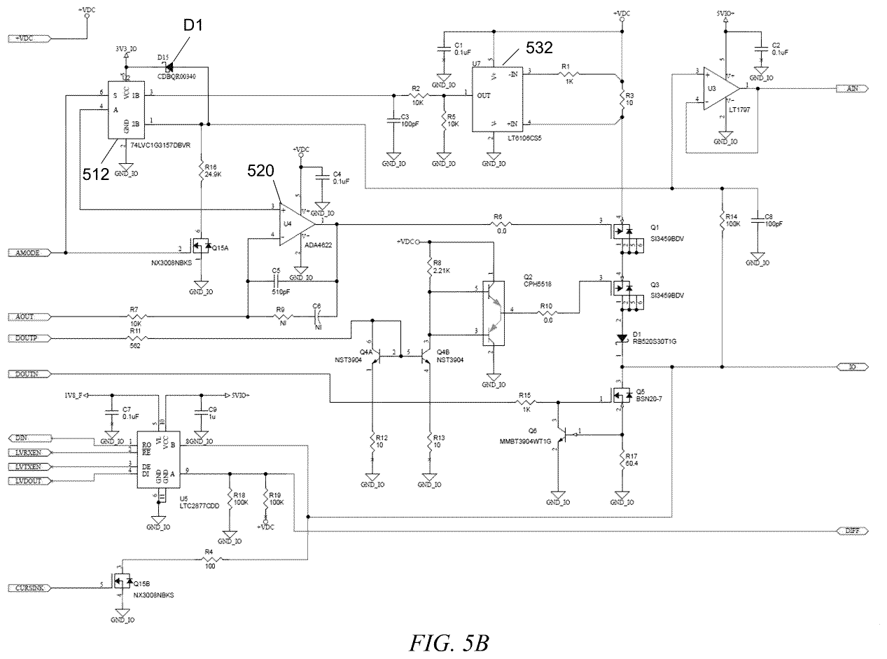

FIG. 5A is a circuit schematic for a flexible input/output circuitry 120 that supports various kinds of single-ended digital and analog signaling types as well as various kinds of differential digital and analog signaling types. Aspects of this circuit are described in the above-referenced U.S. Pat. No. 11,182,326. The flexible I/O circuitry 120 is adapted to transform a received first control signal (e.g., from the SPRe circuitry 115) of a first signaling type (e.g., single-ended digital signal using a first logic-high voltage) to a second control signal of a second signaling type (e.g., single-ended digital signal using a second logic-high voltage that is different from the logic-high voltage). The second signaling type may be supported by a connected device 140, 150, 160 whereas the first signaling type is not. The flexible I/O circuitry 120 can further transform a first data signal of a first signaling type received from the same or a different connected device to a second data signal of a second data signaling type that is supported by a controller (110).

As an example of signal translation by the flexible I/O circuitry 120 of FIG. 5A, the first signaling type having the first logic-high voltage can be applied to the pin or terminal labeled DOUTP. This terminal can connect to a digital output line from the SPRe circuitry 115. The flexible I/O circuitry includes an adjustable high-level logic driver 550, which can be implemented with a current mirror 552 and relay driver 554. The current mirror 552 and relay driver 554 can drive a transistor 584 that switches any suitable voltage +V_{DC} (coupled to the drain of the transistor 584) onto the signaling channel output (labeled IO in FIG. 5A and FIG. 5B). In this manner, the current mirror 552, relay driver 554, and applied voltage +V_{DC} can provide translation of the first digital signal type having a first logic-high voltage received from the SPRe circuitry 115 to a second digital signal type having a second logic-high voltage (determined by +V_{DC}) that is supported by a connected device 140, 150, 160 to which the signaling channel IO connects.

The circuit of FIG. 5A further includes clamping Zener diodes D1 on multiplexing chips 512 (between the chip's supply and a signal input line to the chip). The clamping diode D1 can be used to implement a single-ended analog or single-ended digital signaling type while preventing over-voltages on the signaling channel, which can cause unwanted coupling of the signal to the non-selected port of the multiplexing chip 512.

FIG. 5B is a circuit schematic for a second implementation of a flexible input/output circuitry 120 that can support various kinds of single-ended digital and analog signaling types as well as various kinds of differential digital signaling types. The circuit also includes a clamping diode D1 on its multiplexing chip 512.

### V. Control System Features

It will be appreciated that the SPRe circuitry 115 can provide several beneficial functionalities to the control system 102, some of which have been described above. Such functionalities include:
1. Offloading signal processing and signal generation tasks from the controller 110, providing more time for the controller to perform system managerial and control tasks.
2. Increased speed of signal-processing tasks with dedicated circuit components in the SPRe circuitry 115.
3. Generation of digital or analog waveforms for controlling one or more motors and/or actuators that does not or do not require the controller 110 to produce the waveforms. Instead, the controller 110 can output waveform parameters that are used by the SPRe circuitry 115 to generate the control waveforms.
4. Use of the signal generators 225, 227 for signaling via frequency-shift keying and/or phase-shift keying. For example, the controller 110 can encode a signal onto the output of the digital signal generator 225 (or analog signal generator 227) with frequency-shift or phase-shift keying by repeatedly transmitting alternate values for the period or start phase, respectively, to the selected signal generator to frequency shift or phase shift the output waveform and encode data bits.
5. Improved accuracy of sensor data through the use of LUTs.
6. Implementing a proportional, integral and derivative (PID) controller with the SPRe circuitry 115 with feedback from the dynamic environment provided via the flexible I/O circuitry 120. Logic (implemented in code or hardware) can be added to the SPRe circuitry 115 to compute error between a set point and a measured process value (returned from a sensor in the dynamic environment 105) and to compute proportional, integral, and derivative terms for error correction.

### VI. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A control system comprising:
flexible input/output (I/O) circuitry to communicatively couple to a connected device in the control system, wherein the flexible I/O circuitry is adapted to:
transform a received first control signal of a first signaling type to a second control signal of a second signaling type that is supported by the connected device and that is different than the first signaling type, and
transform a first data signal of the second signaling type received from the connected device to a second data signal of the first signaling type that is supported by a controller of the control system; and
signal-processing-resource circuitry (SPRe circuitry) to communicatively couple to the controller and to communicatively couple to the flexible I/O circuitry, wherein the SPRe circuitry is adapted to offload a signal-processing task relating to a second control signal issued by the controller so that the SPRe circuitry performs the signal-processing task and outputs the first control signal instead of the controller performing the signal-processing task.

2. The control system of claim 1, wherein the signal-processing task comprises generation of a stream of digital values for a waveform, wherein the SPRe circuitry is adapted to output the stream of digital values as the first control signal to the flexible I/O circuitry.

3. The control system of claim 1, wherein:
the SPRe circuitry includes a master signal input line; and
the SPRe circuitry is configurable with a configuration setting to delay execution of the signal-processing task until receipt of a master signal on the master signal input line.

4. The control system of claim 3, wherein the SPRe circuitry is a first SPRe circuitry, the connected device is a first connected device, and the signal-processing task is a first signal-processing task, the system further comprising:
a second SPRe circuitry to communicatively couple to the controller and to communicatively couple to the flexible I/O circuitry, wherein the second SPRe circuitry is adapted to:
offload a second signal-processing task relating to a third control signal issued by the controller so that the second SPRe circuitry performs the second signal-processing task and outputs a third control signal to the flexible I/O circuitry instead of the controller performing the second signal-processing task, and
output the master signal to the first SPRe circuitry in response to executing the second signal-processing task.

5. The control system of claim 3, wherein the SPRe circuitry is a first SPRe circuitry, the connected device is a first connected device, and the signal-processing task is a first signal-processing task, the system further comprising:
a second SPRe circuitry to communicatively couple to the controller and to communicatively couple to the flexible I/O circuitry, wherein the second SPRe circuitry is adapted to:
offload a second signal-processing task relating to the second data signal received from the flexible I/O circuitry so that the second SPRe circuitry performs the second signal-processing task instead of the controller performing the second signal-processing task, and
output the master signal to the first SPRe circuitry in response to executing the second signal-processing task.

6. A control system comprising:
a controller to issue a first control signal of a first signaling type to control a connected device in a dynamic environment;
flexible input/output (I/O) circuitry communicatively coupled to the controller and to the connected device to transform the first control signal to a second control signal of a second signaling type that is different than the first signaling type and that is supported by the connected device; and
signal-processing-resource circuitry (SPRe circuitry) communicatively coupled to the controller and to the flexible I/O circuitry, wherein the SPRe circuitry is adapted to offload a signal-processing task relating to the first control signal from the controller so that the SPRe circuitry performs the signal-processing task instead of the controller performing the signal-processing task.

7. The control system of claim 6, wherein the signal-processing task comprises generation of a stream of digital values for a waveform, wherein the SPRe circuitry is adapted to output the stream of digital values to the flexible I/O circuitry.

8. The control system of claim 7, wherein the SPRe circuitry is configured to receive at least one parameter that defines at least one characteristic of the waveform.

9. The control system of claim 8, wherein the at least one parameter includes:
a starting phase of the waveform; and
an ending phase of the waveform.

10. The control system of claim 7, wherein:
the SPRe circuitry is configured to receive data defining a master signaling channel of the flexible I/O circuitry that is different than an output channel of the flexible I/O circuitry on which the waveform will be output, so that
output of the waveform is contingent upon an event occurring on the master signaling channel.

11. The control system of claim 7, wherein the flexible I/O circuitry is adapted to output a digital waveform based on the stream of digital values received from the SPRe circuitry.

12. The control system of claim 11, wherein the digital waveform is configured to control a motor.

13. The control system of claim 7, wherein the flexible I/O circuitry is adapted to output an analog waveform based on the stream of digital values received from the SPRe circuitry.

14. The control system of claim 13, wherein the analog waveform is configured to excite a resolver.

15. The control system of claim 6, wherein the SPRe circuitry comprises:
at least one digital signal generator; and
at least one analog signal generator.

16. The control system of claim 6, wherein the connected device comprises a resolver and the SPRe circuitry comprises a resolver processor adapted to:
output a waveform to excite the resolver;
receive two signals from the flexible I/O circuitry, wherein the two signals are representative of two analog signals output by the resolver; and
evaluate the two signals to determine a rotation angle of the resolver.

17. The control system of claim 6, wherein the SPRe circuitry comprises at least one field-programmable gate array.

18. The control system of claim 6, wherein the SPRe circuitry comprises at least one universal asynchronous receiver/transmitter (UART) device.

19. The control system of claim 6, wherein the SPRe circuitry comprises at least one data buffer to buffer data received from the controller.

20. The control system of claim 6, wherein the SPRe circuitry comprises at least one data buffer to buffer data that is to be transmitted to the flexible I/O circuitry.

21. The control system of claim 6, wherein the SPRe circuitry comprises at least one data buffer (219, 261) to buffer data that is to be transmitted to the controller.

22. The control system of claim 6, wherein the controller is adapted to negotiate a signaling type with the connected device, the negotiating comprising:
initially using a default signaling type to transmit a first communication to the connected device;
receiving a second communication from the connected device, the second communication identifying the second signaling type to the controller; and
in response to receiving the second communication identifying the second signaling type, configuring the flexible I/O circuitry to transmit the second control signal to the connected device using the second signaling type.

23. The control system of claim 6, wherein the flexible I/O circuitry comprises:
a multiplexing chip to route a signal received by the multiplexing chip on an input port to one of multiple output ports; and
a clamping diode connected between a power supply for the multiplexing chip and the input port to reduce or prevent an overvoltage received at the input port from coupling to a non-selected output port of the multiple output ports.

24. A control system comprising:
a controller to receive information relating to a connected device in a dynamic environment, wherein the information is based upon a signal output from the connected device;
flexible I/O circuitry communicatively coupled to the controller and to the connected device to transform a first signal of a first signaling type from the connected device to a second signal of a second signaling type that is different from the first signaling type and that is supported by the controller; and
SPRe circuitry communicatively coupled to the controller and to the flexible I/O circuitry, wherein the SPRe circuitry is adapted to offload a signal-processing task relating to the second signal received from the flexible I/O circuitry so that the SPRe circuitry performs the signal-processing task instead of the controller performing the signal-processing task.

25. The control system of claim 24, wherein:
the signal-processing task comprises correction of data values received from the connected device, and
the correction of data values uses a look-up table (LUT) stored in memory accessed by the SPRe circuitry.

26. The control system of claim 25, wherein the SPRe circuitry is configured to receive configuration parameters that define entries the LUT.

27. The control system of claim 25, wherein the SPRe circuitry is configured to receive a configuration parameter that identifies the LUT from among a plurality of LUTs stored in the memory.

28. The control system of claim 25, wherein the LUT includes temperature correction values for a thermistor.

29. The control system of claim 24, wherein the SPRe circuitry comprises a filter to filter the second signal.

30. The control system of claim 29, wherein the SPRe circuitry is configured to receive at least one configuration parameter to set or change a configuration of the filter.

31. The control system of claim 30, wherein the at least one parameter includes a time constant τ for the filter.

32. The control system of claim 30, wherein the at least one parameter includes an excursion value E for the filter.

33. The control system of claim 30, wherein the at least one parameter includes a hysteresis value H for the filter.

34. The control system of claim 30, wherein the filter is a digital filter.

35. The control system of claim 24, wherein the SPRe circuitry comprises at least one frequency counter to detect a frequency of a signal received from the flexible I/O circuitry.

36. The control system of claim 24, wherein the SPRe circuitry comprises at least one deserializer to transform a serial data signal received by the SPRe circuitry from the flexible I/O circuitry to a parallel data signal for transmission to the controller.

37. The control system of claim 24, wherein the SPRe circuitry comprises at least one serializer to transform a parallel data signal received by the SPRe circuitry from the controller to a parallel data signal for transmission to the flexible I/O circuitry.

38. The control system of claim 24, wherein the SPRe circuitry comprises at least one field-programmable gate array.

39. The control system of claim 24, wherein the SPRe circuitry comprises at least one universal asynchronous receiver/transmitter (UART) device.

40. The control system of claim 24, wherein the SPRe circuitry comprises at least one data buffer to buffer data received from the controller.

41. The control system of claim 24, wherein the SPRe circuitry comprises at least one data buffer to buffer data that is to be transmitted to the flexible I/O circuitry.

42. The control system of claim 24, wherein the SPRe circuitry comprises at least one data buffer to buffer data that is to be transmitted to the controller.

43. The control system of claim 24, wherein the flexible I/O circuitry comprises:
a multiplexing chip to route a signal received by the multiplexing chip on an input port to one of multiple output ports; and
a clamping diode connected between a power supply for the multiplexing chip and the input port to reduce or prevent an overvoltage received at the input port from coupling to a non-selected output port of the multiple output ports.
